(19) United States
(12) Patent Application Publication
(10) Pub. No.: US 2017/0369688 A1
(43) Pub. Date: Dec. 28, 2017

(54) Thermoformable Propylene Polymer Blends

(71) Applicant: ExxonMobil Chemical Patents Inc., Baytown, TX (US)

(72) Inventors: John M. Donahue, Greenville, SC (US); Jay K. Keung, Humble, TX (US); Adrian G. Barry, Houston, TX (US)

(21) Appl. No.: 15/618,731

(22) Filed: Jun. 9, 2017

Related U.S. Application Data
(60) Provisional application No. 62/353,916, filed on Jun. 23, 2016.

(51) Int. Cl. C08L 23/12; B29C 51/00; B29K 23/00

(52) U.S. Cl. CPC C08L 23/12; B29C 51/002; B29K 2023/12

(57) ABSTRACT

This invention relates to thermoformable blends of propylene polymer and a tackifying resin and thermoformed articles produced from said blends. The thermoformed articles typically have an advantageous combination of good optical properties, stiffness, and barrier properties. This invention further relates to a method of improving the processability of a propylene based polymer by blending the polymer with a tackifying resin.

### PRIORITY

This invention claims priority to and the benefit of U.S. Patent Application Ser. No. 62/353,916, filed Jun. 23, 2016, which is herein incorporated by reference.

### FIELD OF THE INVENTION

The present invention relates to thermoformable blends of propylene based polymer and tackifying resin, the blends having improved processability and resulting in thermoformed articles having improved end use properties.

### BACKGROUND OF THE INVENTION

Polypropylene is a material of choice for thermoformed articles, particularly for food packaging applications, due to such factors as its low density and exceptional heat stability. However, articles formed from thermoformed polypropylene are typically somewhat deficient in clarity, gloss, barrier, embossing definition and stiffness with respect to articles formed from other thermoformed polymers, e.g., polyethylene terephthalate (PET) and polystyrene. For instance, thermoformed polystyrene generally results in articles having superior gloss, embossing definition and stiffness properties, and thermoformed PET generally results in articles having superior clarity, barrier, and stiffness properties.

The undesired end use properties of articles formed from thermoformed polypropylene are generally a result of the low crystallinity level of polypropylene in conjunction with the physical properties of the amorphous region. Additives known as nucleating agents have been have been developed that address the low crystallinity level of polypropylene by increasing its crystallization rate. A number of nucleating agents are known in the art, including dibenzylidene sorbitol acetal derivative compounds (“DBSs”), sodium benzoate, sodium phosphates and talc. However, nucleated polypropylene is still unsatisfactory in many thermoforming applications. Thus, is a need for a means of modifying the physical properties of the amorphous region of the polypropylene.

Tackifying resins, e.g., hydrocarbon resins, have been used as a propylene polymer modifying agent to prepare polymer blends for various applications, particularly films. For instance, blends of polypropylene and hydrocarbon resin for use in biaxially oriented film have been described by Keung, et al., in Extrusion of PP and HCR Blends, PLASTICS ENGINEERING, p. 28-32 (June 2011).

Adhesive blends that include hydrocarbon resins are disclosed in PCT Publication No. WO 2004/087806. U.S. Pat. No. 5,317,070 also discloses adhesive compositions that include a hydrocarbon resin with high glass transition temperature. U.S. Pat. No. 7,745,526 discloses transparent compositions comprising a first polymer component (FPC) that includes polypropylene having a melting point (Tm)≧110° C.; a second polymer component (SPC) that includes a propylene polymer having 60 wt % or more units derived from propylene, including isotactically arranged propylene derived sequences and Tm<105° C. or a Heat of Fusion<45 J/g, or both; and a hydrocarbon resin having a Tg≧20° C. However, as of yet these previously developed polymer blends have not been utilized for providing thermoformed articles that have satisfactory end use properties, e.g., stiffness, as well as sufficient ease of processing.

Other references of interest include U.S. Pat. No. 8,378,045, U.S. Pat. No. 7,452,919, and PCT Publication No. WO 2008/024154.

### SUMMARY OF THE INVENTION

This invention fulfills the need for thermoformed propylene polymer based articles having improved end use properties and ease of processing by providing thermoformable blends of a propylene based polymer and a tackifying resin. Preferably, the tackifying resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof. The invention relates to thermoformed articles formed from these blends, preferably where the resulting articles have an advantageous combination of good optical properties (e.g., low haze), high mechanical strength/stiffness, and good barrier properties (e.g., low oxygen transmission rate). The invention also relates to methods of forming these thermoformed articles, generally by adding a tackifying resin to a propylene based polymer to form a blend, extruding the blend into sheet form, and thermoforming the extruded blend.

The invention further relates to methods of improving the processability of propylene based polymers by adding a tackifying resin. Preferably, the addition of the tackifying resin increases the melt flow rate (MFR) of the propylene based polymer by at least 25%.

### DETAILED DESCRIPTION

Disclosed herein are thermoformable blends comprising a propylene based polymer and a tackifying resin, thermoformed articles formed therefrom, and methods of producing the same. Without wishing to be bound by theory, it is believed that the tackifying resin modifies the physical properties of the amorphous region of the propylene based polymer, resulting in a blend that is more easily processed and a thermoformed article having improved end use properties. For instance, it is believed that the addition of the tackifying resin increases the elastic modulus of the propylene based polymer, resulting in a thermoformed article having improved mechanical strength and stiffness, and increases the Tg of the propylene based polymer, thereby enhancing embossing definition of the thermoformed article. The thermoformable blends and articles formed therefrom are particularly useful in packaging applications.

The addition of the tackifying resin is also believed to enhance the processability of the propylene based polymer by causing an increase in the MFR of the blend over that of the propylene based polymer. Preferably, the addition of the tackifying resin increases the MFR of the blend over that of the propylene based polymer from about 20% to about 80%, or from about 25% to about 50%, or from about 30% to about 40%.

### Definitions

The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, when a polymer is referred to as “comprising a monomer,” the monomer is present in the polymer in the polymerized form of the monomer or in the derivative form of the monomer.

As used herein, unless specified otherwise, the term “copolymer(s)” refers to polymers formed by the polymerization of at least two different monomers. For example, the term “copolymer” includes the copolymerization reaction product of ethylene and an alpha-olefin, such as 1-hexene. However, the term “copolymer” is also inclusive of, for example, the copolymerization of a mixture of ethylene, propylene, 1-hexene, and 1-octene.

As used herein, “isotactic” is defined as having at least 40% isotactic pentads according to analysis by C-NMR. “Substantially isotactic” is defined as having at least 97% isotactic pentads.

As used herein, “thermoplastic” includes only those thermoplastic materials that have not been functionalized or substantially altered from their original chemical composition. For example, as used herein, polypropylene, propylene ethylene copolymers, propylene alpha-olefin copolymers, polyethylene and polystyrene are thermoplastics. However, maleated polyolefins are not within the meaning of thermoplastic as used herein.

For purposes of this invention and the claims thereto, a “nucleating agent” or “nucleator” is a molecule having a molecular weight of less than 1,000 g/mole that decreases the crystallization time of thermoplastic materials, examples of which include metal salts or organic acids, sodium benzoate, and other compounds known in the art. For purposes of the invention, a “clarifying agent” is a nucleating agent that is soluble in the melt phase of the thermoplastic materials.

As used herein, “thermoforming” refers to a process of forming at least one pliable plastic sheet into a desired shape.

As used herein, “molecular weight” means weight average molecular weight (“Mw”). Mw is determined using Gel Permeation Chromatography. Molecular Weight Distribution (“MWD”) means Mw divided by number average molecular weight (“Mn”). (For more information, see U.S. Pat. No. 4,540,753 to Cozewith et al. and references cited therein, and in Verstrate et al., 21 Macromolecules 3360 (1998)). The “Mz” value is the high average molecular weight value, calculated as discussed by A. R. Cooper in Concise Encyclopedia of Polymer Science and Engineering 638-39 (J. I. Kroschwitz, ed. John Wiley & Sons 1990).

As used herein, weight percent (“wt %”), unless noted otherwise, means a percent by weight of a particular component based on the total weight of the mixture containing the component. For example, if a mixture contains three pounds of sand and one pound of sugar, then the sand comprises 75 wt % (3 lbs. sand/4 lbs. total mixture) of the mixture and the sugar 25 wt %.

For purposes of the invention, the melting point (T_{M}) is determined by differential scanning calorimetry (DSC).

When referred to herein, a polymer's “clarity,” “clarity percentage,” “haze” or “haze percentage” are determined in the absence of any colorant, colored pigments, dyes or other additives meant to affect the final color or opacity of the polymer. In particular, if an inventive composition described herein satisfies the clarity and haze percentages of the given formulae before the addition of colorants, colored pigments, dyes or other additives, but does not after the addition of some additive, it does not cease to be an inventive composition according to the present invention.

For purposes of the invention, haze and clarity (measured in %) are determined using a BYK-Gardner USA HazeGard PLUS hazemeter. Haze is determined according to ASTM D1003 Procedure A.

For purposes of the invention, top load compression strength is determined according to ASTM D 2659.

For purposes of the invention, Melt Flow Rates (MFR) are determined in accordance with ASTM D 1238 at 230° C. and 2.16 Kg weight.

### Propylene Based Polymer

The thermoformable blends generally comprise one or more propylene based polymers. The one or more propylene based polymers should be present in the blend in an amount ranging from a lower limit of about 82%, 85%, 87.5%, or 90% by weight based on the total weight of the blend, to an upper limit of about 92.5%, 95%, 97.5%, or 99% by weight based on the total weight of the blend, such as from about 82% to about 99% by weight based on the total weight of the blend, or from about 85% to about 95% by weight based on the total weight of the blend. Often, the propylene based polymer is present in the blend in an amount of about 92.5% by weight based on the total weight of the blend.

Suitable propylene based polymers contain propylene in amounts greater than about 50 wt %, preferably greater than about 80 wt %, ideally greater than about 90 wt %, such as from about 93 wt % to about 99.5 wt %. The crystallinity is preferably of the isotactic propylene type. Optional comonomer(s) may be selected from ethylene and alpha-olefins having from 4 to 12 carbon atoms, preferably ethylene. Preferably, the comonomer content can range from a low of about 0.1, 0.25, 0.5, 1, 2, 3, 4, or 6 wt % to a high of about 1, 3, 5, 7, 8, 9, 15, or 20 wt %, such as from about 0.5 wt % to about 7 wt %.

Preferably, the propylene based polymer contains one or more propylene homopolymers, propylene block copolymers, propylene copolymers, or a combination of one or more thereof. Preferred propylene copolymers include, but are not limited to, terpolymers of propylene, impact copolymers of propylene, random copolymers of propylene and mixtures thereof. Such propylene copolymers and methods for making the same are described in U.S. Pat. No. 6,342,565.

Often, the propylene based polymer is or includes polypropylene. Suitable polypropylene polymers include homopolymers and copolymers of propylene or mixtures thereof. Products that include one or more propylene monomers polymerized with one or more additional monomers may be more commonly known as random copolymers (RCP) or impact copolymers (ICP) (e.g., an intimate blend of polypropylene homopolymer and an ethylene-propylene elastomer, also known in the art as heterophasic copolymers). Preferred RCPs include single phase propylene copolymers having up to about 9 wt %, preferably about 2 wt % to about 8 wt %, of an alpha olefin comonomer, preferably ethylene.

Often, the polypropylene polymer is or comprises a “tailored crystallinity resin” (“TCR”). Suitable TCRs include any modified polypropylene comprising an in situ reactor blend of a higher molecular weight propylene/ethylene random copolymer and a lower molecular weight substantially isotactic homopolypropylene, such as those described in U.S. Pat. No. 4,950,720, incorporated by reference as if fully disclosed herein.

Preferred polypropylene polymers used in the compositions described herein have a melting point above about 110° C., include at least 90 wt % propylene units, and contain isotactic sequences of those units. Alternatively, the polypropylene may include atactic sequences or syndiotactic sequences. The polypropylene can either derive exclusively from propylene monomers (i.e., having only propylene units) or derive from mainly propylene (more than 80% propylene) with the remainder derived from olefins, particularly ethylene, and/or C₄-C₁₀ α-olefins.

A preferred polypropylene is isotactic polypropylene. An illustrative isotactic polypropylene has a weight average molecular weight (Mw) from about 200,000 to about 600,000 g/mole, and a number average molecular weight (Mn) from about 80,000 to about 200,000 g/mole. A more preferable isotactic polypropylene has an Mw from about 300,000 to about 500,000 g/mole, and an Mn from about 90,000 to about 150,000 g/mole. In any embodiment, the isotactic polypropylene may have a molecular weight distribution (Mw/Mn) (MWD), also referred to as “polydispersity index” (PDI), within a range having a low of 1.5, 1.8. or 2.0 and a high of 4.5, 5, 10, 20, or 40, such as from 1.5 to 4.0.

Preferably, the isotactic polypropylene has a melt temperature (Tₘ) ranging from a low of about 150° C., 155° C., or 160° C. to a high of about 160° C., 170° C., or 175° C., such as from 155° C. to 170° C. The isotactic polypropylene preferably has a glass transition temperature (T_{g}) ranging from a low of about −5° C., −3° C., or 0° C. to a high of about 2° C., 5° C., or 10° C., such as from −3° C. to 5° C. The crystallization temperature (Tₑ) of the isotactic polypropylene component preferably ranges from a low of about 95° C., 100° C., or 105° C. to a high of about 110° C., 120° C. or 130° C., such as 100° C. to 120° C., as measured by differential scanning calorimetry (DSC) at 10° C./min. Furthermore, the isotactic polypropylene preferably has a crystallinity of at least 25 percent as measured by DSC.

Generally, the isotactic polypropylene has a melt flow rate of less than about 10 dg/min, often less than about 5 dg/min, and often less than about 3 dg/min. Often, the isotactic polypropylene has a melt flow rate ranging from about 2 to about 5 dg/min. A preferred isotactic polypropylene has a heat of fusion of greater than 75 J/g, or greater than 80 J/g, or greater than 90 J/g to a high of about 150 J/g, such as from about 80 J/g to about 120 J/g.

In any embodiment, the isotactic polypropylene may have a density of from about 0.85 g/cc to about 0.93 g/cc. Preferably, the isotactic polypropylene has a density of from about 0.88 g/cc to about 0.92 g/cc, more preferably from about 0.90 g/cc to about 0.91 g/cc.

Such an isotactic polypropylene may be synthesized using any polymerization technique known in the art such as, but not limited to, the “Phillips catalyzed reactions,” conventional Ziegler-Natta type polymerizations, and single-site organometallic compound catalysis, such as metallocene catalysis, for example. Illustrative metallocene catalyst compounds include, but are not limited to, the reaction products of metallocene-alumoxane and metallocene-ionic activator reagents. Illustrative polymerization methods include, but are not limited to, slurry, bulk phase, solution phase, and any combination thereof. Polymerization may be carried out by a continuous or batch process in a single stage, such as a single reactor, or in two or more stages, such as in two or more reactors arranged in parallel or series.

Often, the propylene based polymer is nucleated with one or more nucleating agents prior to the addition of the tackifying resin. Alternatively, the propylene based polymer is non-nucleated, i.e., nucleating agents are absent.

In any embodiment, suitable nucleating agents may be selected from the group consisting of sodium benzoate, talc, glycerol alkoxide salts, cyclic carboxylic acid salts, bicyclic carboxylic acid salts, glycerolates, and hexahydrophtalic acid salts. Nucleating agents include HYPERFORM™ additives, such as HPN-68, HPN-68L, HPN-20, HPN-20E, MILLAD™ additives (e.g., MILLAD™ 3988) (Milliken Chemicals, Spartanburg, S.C.) and organophosphates such as NA-11 and NA-21 (Amfine Chemicals, Allendale, N.J.). In any embodiment, suitable nucleating agents may comprise at least one bicyclic carboxylic acid salt. In any embodiment, suitable nucleating agents may comprise bicycloheptane dicarboxylic acid, disodium salt such as bicyclo [2.2.1] heptane dicarboxylate. In any embodiment, suitable nucleating agents may be a blend of components comprising bicyclo [2.2.1] heptane dicarboxylate, disodium salt, 13-docosenamide, and amorphous silicon dioxide. In any embodiment, suitable nucleating agents may be cyclohexanedicarboxylic acid, calcium salt or a blend of cyclohexanedicarboxylic acid, calcium salt, and zinc stearate. In any embodiment, suitable nucleating agents include clarifying agents.

### Tackifying Resin

The thermoformable blends generally comprise one or more tackifying resins. The tackifying resin should be present in the blend in an amount ranging from a lower limit of about 1%, 2.5%, 5%, or 7.5% by weight based on the total weight of the composition, to an upper limit of about 10%, 12.5%, 15%, or 18% by weight based on the total weight of the blend, such as from about 2.5% to about 15% by weight based on the total weight of the blend, or from about 5% to about 10% by weight based on the total weight of the blend. Often, the tackifying resin is present in the blend in an amount of about 7.5% by weight based on the total weight of the blend.

Suitable tackifying resins include, but are not limited to, aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, cycloaliphatic/aromatic at least partially hydrogenated hydrocarbon resins, polyterpene resins, terpene-phenol resins, rosin esters, rosin acids, grafted resins, and mixtures of two or more of the foregoing. The tackifying resins may be polar or apolar.

In any embodiment, suitable tackifying resins may comprise one or more hydrocarbon resins produced by the thermal polymerization of cyclopentadiene (CPD) or substituted CPD, which may further include aliphatic or aromatic monomers as described later. The hydrocarbon resin may be a non-aromatic resin or an aromatic resin. The hydrocarbon resin may have an aromatic content between 0 wt % and 60 wt %, or between 1 wt % and 60 wt %, or between 1 wt % and 40 wt %, or between 1 wt % and 20 wt %, or between 10 wt % and 20 wt %. Alternatively or additionally, the hydrocarbon resin may have an aromatic content between 15 wt % and 20 wt %, or between 1 wt % and 10 wt %, or between 5 wt % and 10 wt %. Preferred aromatics that may be in the hydrocarbon resin include one or more of styrene, indene, derivatives of styrene, and derivatives of indene. Particularly preferred aromatic olefins include styrene, alpha-methylstyrene, beta-methylstyrene, indene, and methylindenes, and vinyl toluenes. Styrenic components include styrene, derivatives of styrene, and substituted sytrenes. In general, styrenic components do not include fused-rings, such as indenics.

In any embodiment, suitable tackifying resins may comprise hydrocarbon resins produced by the catalytic (cationic) polymerization of linear dienes. Such monomers are primarily derived from Steam Cracked Naphtha (SCN) and include C₅ dienes such as piperylene (also known as 1,3-pentadiene). Polymerizable aromatic monomers can also be used to produce resins and may be relatively pure, e.g. styrene, -methyl styrene, or from a C₉-aromatic SCN stream. Such aromatic monomers can be used alone or in combination with the linear dienes previously described. “Natural” monomers can also be used to produce resins, e.g., terpenes such as alpha-pinene or beta-carene, either used alone or in high or low concentrations with other polymerizable monomers. Typical catalysts used to make these resins are AlCl₃ and BF₃, either alone or complexed. Mono-olefin modifiers such as 2-methyl, 2-butene may also be used to control the molecular weight distribution (MWD) of the final resin. The final resin may be partially or totally hydrogenated.

In any embodiment, suitable tackifying resins may be at least partially hydrogenated or substantially hydrogenated. As used herein, “at least partially hydrogenated” means that the material contains less than 90% olefinic protons, or less than 75% olefinic protons, or less than 50% olefinic protons, or less than 40% olefinic protons, or less than 25% olefinic protons, such as from 20% to 50% olefinic protons. As used herein, “substantially hydrogenated” means that the material contains less than 5% olefinic protons, or less than 4% olefinic protons, or less than 3% olefinic protons, or less than 2% olefinic protons, such as from 1% to 5% olefinic protons. The degree of hydrogenation is typically conducted so as to minimize and avoid hydrogenation of the aromatic bonds.

In any embodiment, suitable tackifying resins may comprise one or more oligomers such as dimers, trimers, tetramers, pentamers, and hexamers. The oligomers may be derived from a petroleum distillate boiling in the range of 30° C.-210° C. The oligomers may be derived from any suitable process and are often derived as a byproduct of resin polymerization. Suitable oligomer streams may have number average molecular weights (Mn) between 130 and 500, or between 130 and 410, or between 130 and 350, or between 130 and 270, or between 200 and 350, or between 200 and 320. Examples of suitable oligomer streams include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present. These include C₄-C₆ mono-olefins and terpenes. The oligomers may comprise one or more aromatic monomers and may be at least partially hydrogenated or substantially hydrogenated.

Preferably, suitable tackifying resins a dicyclopentadiene, cyclopentadiene, and methylcyclopentadiene derived content of about 60 wt % to about 100 wt % of the total weight of the tackifying resin. In any embodiment, suitable tackifying resins may have a dicyclopentadiene, cyclopentadiene, and methylcyclopentadiene derived content of about 70 wt % to about 95 wt %, or about 80 wt % to about 90 wt %, or about 95 wt % to about 99 wt % of the total weight of the tackifying resin. Preferably, the tackifying resin may be a hydrocarbon resin that includes, in predominant part, dicyclopentadiene derived units. The term “dicyclopentadiene derived units”, “dicyclopentadiene derived content”, and the like refers to the dicyclopentadiene monomer used to form the polymer, i.e., the unreacted chemical compound in the form prior to polymerization, and can also refer to the monomer after it has been incorporated into the polymer, which by virtue of the polymerization reaction typically has fewer hydrogen atoms than it does prior to the polymerization reaction.

In any embodiment, suitable tackifying resins may have a dicyclopentadiene derived content of about 50 wt % to about 100 wt % of the total weight of the tackifying resin, more preferably about 60 wt % to about 100 wt % of the total weight of the tackifying resin, even more preferably about 70 wt % to about 100 wt % of the total weight of the tackifying resin. Accordingly, in any embodiment, suitable tackifying resins may have a dicyclopentadiene derived content of about 50% or more, or about 60% or more, or about 70% or more, or about 75% or more, or about 90% or more, or about 95% or more, or about 99% or more of the total weight of the tackifying resin.

Suitable tackifying resins may include up to 5 wt % indenic components, or up to 10 wt % indenic components. Indenic components include indene and derivatives of indene. Often, the tackifying resin includes up to 15 wt % indenic components. Alternatively, the tackifying resin is substantially free of indenic components.

Preferred tackifying resins have a melt viscosity of from 300 to 800 centipoise (cPs) at 160° C., or more preferably of from 350 to 650 cPs at 160° C. Preferably, the melt viscosity of the tackifying resin is from 375 to 615 cPs at 160° C., or from 475 to 600 cPs at 160° C. The melt viscosity may be measured by a Brookfield viscometer with a type “J” spindle according to ASTM D-6267.

Suitable tackifying resins have an Mw greater than about 600 g/mole or greater than about 1000 g/mole. In any embodiment, the tackifying resin may have an Mw of from about 600 to about 1400 g/mole, or from about 800 g/mole to about 1200 g/mole. Preferred tackifying resins have a weight average molecular weight of from about 800 to about 1000 g/mole. Suitable tackifying resins may have an Mn of from about 300 to about 800 g/mole, or from about 400 to about 700 g/mole, or more preferably from about 500 to about 600 g/mole. Suitable tackifying resins may have an Mz of from about 1250 to about 3000 g/mole, or more preferably from about 1500 to about 2500 g/mole. Mw, Mn, and Mz may be determined by gel permeation chromatography (GPC). In any embodiment, suitable tackifying resins may have a polydispersion index (“PDI”, PDI=Mw/Mn) of 4 or less, preferably from 1.3 to 1.7.

Preferred tackifying resins have a glass transition temperature (Tg) of from about 30° C. to about 200° C., or from about 0° C. to about 150° C., or from about 50° C. to about 160° C., or from about 50° C. to about 150° C., or from about 50° C. to about 140° C., or from about 80° C. to about 100° C., or from about 85° C. to about 95° C., or from about 40° C. to about 60° C., or from about 45° C. to about 65° C. Preferably, suitable tackifying resins have a Tg from about 60° C. to about 90° C. Differential scanning calorimetry (DSC) is used to determine glass transition temperature.

Specific examples of commercially available hydrocarbon resins include Oppera PR 100, 100A, 101, 102, 103, 104, 105, 106, 111, 112, 115, and 120 materials, and Oppera PR 131 hydrocarbon resins, all available from ExxonMobil Chemical Company, ARKON™ M90, M100, M115 and M135 and SUPER ESTER™ rosin esters available from Arakawa Chemical Company of Japan, SYLVARES™ phenol modified styrene- and methyl styrene resins, styrenated terpene resins, ZONATAC terpene-aromatic resins, and terpene phenolic resins available from Arizona Chemical Company, SYLVATAC™ and SYLVALITE™ rosin esters available from Arizona Chemical Company, NORSOLENE™ aliphatic aromatic resins available from Cray Valley of France, DERTOPHENE™ terpene phenolic resins available from DRT Chemical Company of Landes, France, EASTOTAC™ resins, PICCOTACT™ C5/C9 resins, REGALITE™ and REGALREZ™ aromatic and REGALITE™ cycloaliphatic/aromatic resins available from Eastman Chemical Company of Kingsport, Tenn., WINGTACK™ ET and EXTRA available from Goodyear Chemical Company, FORAL™, PENTALYN™, AND PERMALYN™ rosins and rosin esters available from Hercules (now Eastman Chemical Company), QUINTONE™ acid modified C5 resins, C5/C9 resins, and acid modified C5/C9 resins available from Nippon Zeon of Japan, and LX™ mixed aromatic/cycloaliphatic resins available from Neville Chemical Company, CLEARON hydrogenated terpene aromatic resins available from Yasuhara. The preceding examples are illustrative only and by no means limiting.

These commercial compounds generally have a Ring and Ball softening point (measured according to ASTM E-28 (Revision 1996)) of about 10° C. to about 200° C., more preferably about 50° C. to about 180° C., more preferably about 80° C. to about 175° C., more preferably about 100° C. to about 160° C., more preferably about 110° C. to about 150° C., and more preferably about 125° C. to about 140° C., wherein any upper limit and any lower limit of softening point may be combined for a preferred softening point range. For hydrocarbon resins a convenient measure is the ring and ball softening point determined according to ASTM E-28.

### Additives

Optionally, additional additives may be present in the thermoformable blends that are known in the art for modifying polymer compositions to provide particular physical characteristics or effects. The use of appropriate additives is well within the skill of one in the art. Examples of such additives include colored pigments, UV stabilizers, antioxidants, light stabilizers, flame retardants, antistatic agents, biocides, viscosity-breaking agents, impact modifiers, plasticizers, fillers, reinforcing agents, lubricants, mold release agents, blowing agents, and the like. Such additives may comprise from about 0.1% to about 10% by weight based on the total weight of the blend.

### Blending & Processing

Often, the individual materials and components, such as the one or more propylene based polymers, one or more tackifying resins, other additives, plasticizers, etc., may be blended by melt-mixing at a temperature above the melting temperature of the propylene based polymer(s). Examples of machinery capable of generating the shear and mixing include a Banbury mixer, Buss co-kneader, Farrel continuous mixer, planetary extruder, single screw extruder, co-rotating multi-screw screw extruder, counter rotating multi-screw screw extruder, co-rotating intermeshing extruder or ring extruder. The type and intensity of mixing, temperature, and residence time required can be achieved by the choice of one of the above machines in combination with the selection of kneading or mixing elements, screw design, and screw speed (<3000 RPM). Optional additives can be introduced into the composition at the same time as the other components or later at downstream in case of using an extruder or Buss kneader or only later in time. The additives can be added to the blend in pure form or in masterbatches.

Preferably, the blended components are formed into a sheet, ideally via extrusion, which may be then thermoformed into a desirable shape, typically the shape of the end use article. An embodiment of the thermoforming sequence is described. First, the sheet is placed on a shuttle rack to hold it during heating. The shuttle rack indexes into the oven which pre-heats the sheet before forming. Once the sheet is heated, the shuttle rack indexes back to the forming tool. The sheet is then vacuumed onto the forming tool to hold it in place and the forming tool is closed. The forming tool can be either “male” or “female” type tools. The tool stays closed to cool the sheet and the tool is then opened. The shaped sheet is then removed from the tool.

Thermoforming is accomplished by vacuum, positive air pressure, plug-assisted vacuum forming, or combinations and variations of these, once the sheet of material reaches thermoforming temperatures of from 140° C. to 185° C. or higher. A pre-stretched bubble step is used, especially on large parts, to improve material distribution. Often, an articulating rack lifts the heated laminate towards a male forming tool, assisted by the application of a vacuum from orifices in the male forming tool. Once the laminate is firmly formed about the male forming tool, the thermoformed shaped laminate is then cooled, typically by blowers. Plug-assisted forming is generally used for small, deep drawn parts. Plug material, design, and timing can be critical to optimization of the process. Plugs made from insulating foam avoid premature quenching of the plastic. The plug shape is usually similar to the mold cavity, but smaller and without part detail. A round plug bottom will usually promote even material distribution and uniform side-wall thickness. For a semicrystalline polymer such as polypropylene, fast plug speeds generally provide the best material distribution in the part. The shaped sheet is then cooled in the mold. Sufficient cooling to maintain a mold temperature of 30° C. to 65° C. is desirable. Often, the part is below 90° C. to 100° C. before ejection. The shaped sheet is then trimmed of excess sheet material before any further processing.

### Thermoformed Articles

The shaped articles of the method herein described may be bottles, deli trays, food packaging, containers, medical devices, such as syringes, and eating and drinking utensils such as cups, plates and plasticware. The thermoformable blends are particularly suitable for use in thermoformed extruded sheets, particularly multilayer thermoformed extruded sheets, wherein at least layer of the sheet comprises the blend.

Preferably, the thermoformed articles described herein exhibit an advantageous combination of improved optical properties, mechanical strength/stiffness, and barrier properties. Preferably, the thermoformed articles have a haze value of from about 1% to about 10%, as measured in accordance with ASTM D1003 Procedure A, and a clarity value of about 80% to about 100%, preferably from about 95% about 100%. Preferably, the addition of the tackifying resin modifier results in thermoformed articles having a top load compression strength of from about 5% to about 30% greater, or about 10% to about 25% greater, or about 12% to about 15% greater, than thermoformed articles formed from the propylene based polymer in the absence of tackifying resin. Preferably, the thermoformed articles have an oxygen transmission rate (OTR) ranging from about 70 to about 150 (cc·mil)/100 in²-day, preferably from about 70 to about 125 (cc·mil)/100 in²-day, preferably from about 70 to about 110 (cc·mil)/100 in²-day, preferably from about 70 to about 100 (cc·mil)/100 in²-day, and ideally from about 70 to about 85 (cc·mil)/100 in²-day. Preferably, the thermoformed articles have a water vapor transmission rate (WVTR) ranging from about 3 to about 8 (g·mil)/m²-day, preferably from about 3 to about 7 (g·mil)/m²-day, preferably from about 3 to about 6 (g·mil)/m²-day, preferably from about 3 to about 5 (g·mil)/m²-day, and ideally from about 3 to about 4 (g·mil)/m²-day.

Often, the thermoformed article is in the form of a cup. Preferred dimensions of the thermoformed cups include a depth of from about 3 in (76.2 mm) to about 6 in (152.4 mm), a width of from about 2 in (50.8 mm) to about 4 in (101.6 mm), and a sidewall thickness of from about 5 mils (0.127 mm) to about 15 mils (0.381 mm). Preferably, the sidewall of thermoformed cups formed in accordance with this invention have a haze value from about 1% to about 10%, or from about 1% to about 6%, or from 4% to 6%, or from about 3% to 5% as measured in accordance with ASTM D1003 Procedure A at a thickness of 11 mils (0.279 mm). Preferably, the sidewall of thermoformed cups formed in accordance with this invention have a clarity value at a thickness of 11 mils greater than about 80%, preferably greater than about 90%, preferably greater than about 95%, such as from about 80% to about 100%, or from 90% to 100%, or from about 95% to 99%. Preferably, thermoformed cups as formed in accordance with this invention have a top load compression strength above about 200 N, preferably above about 250 N, preferably above about 280 N to a high of about 300 N, preferably about 325 N, preferably about 350 N, such as from about 250 N to about 325 N, or from about 280 N to about 325 N.

The various descriptive elements and numerical ranges disclosed herein for the inventive thermoformable blends and process to make such compositions can be combined with other descriptive elements and numerical ranges to describe the invention(s); further, for a given element, any upper numerical limit can be combined with any lower numerical limit described herein, including the examples in jurisdictions that allow such combinations. The features of the inventions are demonstrated in the following non-limiting examples.

### EXAMPLES

### Materials

PP4712E1—non-nucleated polypropylene homopolymer having a density of 0.900 g/cm³ and an MFR (2.16 kg @230° C., ASTM D-1238) of 2.8 g/10 min., available from ExxonMobil Chemical Company.

PP6272NE1—nucleated polypropylene homopolymer having a density of 0.900 g/cm³ and an MFR (2.16 kg @230° C., ASTM D-1238) of 2.8 g/10 min., available from ExxonMobil Chemical Company.

Oppera PR 100A is an amorphous cyclic olefin oligomer hydrocarbon resin available from ExxonMobil Chemical Company.

### Preparation of Extruded Sheets & Thermoformed Articles

Sheet samples of the inventive polymers were extruded on a Reifenhauser Mirex-W sheet extruder equipped with an 80 mm, 33:1 L/D barrier screw with Maddox and pineapple mixing sections. The sheet die has a symmetrical, coathanger manifold. The polishing stack, consisting of 16 inch wide rolls equipped with temperature controls, was run in an upstack configuration.

The shaped parts and articles were formed with an Illig RDM 54 k thermoformer equipped with longitudinal row control for both upper and lower infrared ceramic heaters. The forming mold was polished aluminum and produced drinking cups 11 mils thick, 91.4 mm wide and 140 mm deep from 1.9 mm sheet. For more information concerning thermoforming, see PCT Publication No. WO 2008/024154 at paragraphs [0045] and [0046].

Optical properties of the thermoformed articles are summarized in Table 1.

TABLE 1

| | Oppera ™ PR | Haze | Clarity |
|---|---|---|---|
| Polymer | 100A (wt %) | (%) | (%) |
| ExxonMobil ™ | 0 | 6.38 ± 0.35 | 92.4 ± 0.2 |
| PP4712E1 | (COMPARATIVE) | | |
| | 7.5 | 10.6 ± 0.83 | 86.8 ± 1.4 |
| ExxonMobil ™ | 0 | 3.19 ± 0.11 | 98.6 ± 0.1 |
| PP6272NE1 | (COMPARATIVE) | | |
| | 7.5 | 2.87 ± 0.11 | 98.9 ± 0.1 |
| | 15 | 3.00 ± 0.11 | 98.8 ± 0.1 |

As seen from Table 1, the addition of Oppera™ PR 100A improved the optical properties of thermoformed articles formed from the nucleated polypropylene homopolymer, ExxonMobil™ PP6272NE1. In particular, the addition of Oppera™ PR 100A at a concentration of 7.5 wt % resulted in a particularly advantageous reduction in haze of the nucleated polypropylene homopolymer.

Strength properties of the thermoformed articles are summarized in Table 2.

TABLE 2

| | Oppera ™ PR 100A | Top Load |
|---|---|---|
| Polymer | (wt %) | Compression (N) |
| ExxonMobil ™ | 0 (COMPARATIVE) | 266.38 ± 13.2 |
| PP4712E1 | 7.5 | 298.90 ± 27.9 |
| ExxonMobil ™ | 0 (COMPARATIVE) | 252.08 ± 19.7 |
| PP6272NE1 | 7.5 | 293.39 ± 15.0 |
| | 15 | 312.62 ± 48.8 |

As seen from Table 2, the addition of Oppera™ PR 100A increased the top load compression strength (correlating to an increase in stiffness) of thermoformed articles formed from both the nucleated polypropylene homopolymer, ExxonMobil™ PP6272NE1, and the non-nucleated polypropylene homopolymer, ExxonMobil™ PP4712E1. More specifically, the addition of Oppera™ PR 100A at a concentration of 7.5 wt % increased the top load compression strength by 12% in the articles formed from the non-nucleated polymer and by 16% in the articles formed from the nucleated polymer. Moreover, the addition of Oppera™ PR 100A at a concentration of 15 wt % in the nucleated polymer increased the top load compression strength by 24%.

Barrier properties of the thermoformed articles were measured using a MOCON PERMATRAN-W 700 permeability tester. WVTR measurements were performed at 37.8° C. 100% relative humidity (RH), 760 mm Hg pressure, and a flow rate of 99.96 standard cubic centimeters per minute (SCCM). OTR measurements were performed using a mixture of 21% oxygen and 79% nitrogen at 23.0° C. 0% RH, 760 mm Hg pressure, and a flow rate of 18.83 SCCM. The results of both the WVTR and OTR measurements were normalized to a thickness of 1 mm These results are recorded in Table 3.

TABLE 3

| | Oppera ™ PR | WVTR (g · mil/ | OTR (cc · mil/ |
|---|---|---|---|
| Polymer | 100A (wt %) | m²-day) | 100 in²-day) |
| ExxonMobil ™ | 0 (COMPARATIVE) | 8.14 ± 0.49 | 102.46 ± 37.5 |
| PP4712E1 | 7.5 | 3.64 ± 0.19 | 73.70 ± 9.49 |
| ExxonMobil ™ | 0 (COMPARATIVE) | 6.16 ± 0.00 | 136.52 ± 34.4 |
| PP6272NE1 | 7.5 | 4.06 ± 0.42 | 104.82 ± 0.66 |
| | 15 | 2.41 ± 1.31 | 86.39 ± 8.51 |

As seen from Table 3, the addition of Oppera™ PR 100A reduced the oxygen and water vapor transmission rates, i.e., improved the barrier properties, of thermoformed articles formed from both the nucleated polypropylene homopolymer, ExxonMobil™ PP6272NE1, and the non-nucleated polypropylene homopolymer, ExxonMobil™ PP4712E1.

### Processability

Varying concentrations of Oppera™ PR 100A were added to the nucleated polypropylene homopolymer, ExxonMobil™ PP6272NE1, to determine the effects of adding a tackifying resin on the processability of propylene polymer. These results are summarized in Table 4.

TABLE 4

| | Oppera ™ PR 100A | |
|---|---|---|
| Polymer | (wt %) | MFR (g/10 min) |
| ExxonMobil ™ | 0 (COMPARATIVE) | 3.22 |
| PP6272NE1 | 2.5 | 3.44 |
| | 5 | 3.63 |
| | 10 | 4.31 |

As seen from Table 4, the blends of polypropylene with Oppera™ PR 100A exhibited increases in MFR above that of the neat polypropylene, indicating increased processability.

### Experimental Test Methods

All molecular weights are number average in g/mole unless otherwise noted. Unless otherwise noted, physical and chemical properties described herein are measured using the following test methods.

### Gel Permeation Chromatography (GPC)

Molecular weights (number-average molecular weight (Mn), weight-average molecular weight (Mw), and Z-average molecular weight (Mz)) are determined by size exclusion/gel permeation chromatography using an HLC-8320GPC EcoSEC GPC System by Tosoh BioScience. The unit is equipped with internal, on-line differential refractive index (DRI) and optional ultraviolet (UV) detectors.

The GPC uses a series of three Polymer Laboratories PLgel 10μ Mixed-B columns for size separation at the following conditions:
40° C. test temperature for both pump and column ovens
50 minute test duration
Tetrahydrofuran (THF) for sample solvent and mobile phase
Solution concentration is 24 mg/9 mL, and is filtered through 0.45 μm polytetrafluoroethylene (PTFE) syringe filter via clean glass syringe
Flow rate of 1 mL/min
Sample injection volume of 200 μL
   Columns are calibrated up to 40,000 (Mw) using EasiVial PS-Low calibration standards (Agilent Technologies).

### Differential Scanning Calorimetry (DSC)

Crystallization temperature (T_{c}) and melting temperature (or melting point, Tₘ) are measured using Differential Scanning calorimetry (DSC) on a commercially available instrument (e.g., TA Instruments 2920 DSC). Typically, 6 to 10 mg of molded polymer or plasticized polymer are sealed in an aluminum pan and loaded into the instrument at room temperature (23-24° C.). Melting data (first heat) is acquired by heating the sample to at least 30° C. above its melting temperature, typically 220° C. for polypropylene, at a heating rate of 10° C./min. The sample is held for at least 5 minutes at this temperature (220° C.) to destroy its thermal history. Crystallization data are acquired by cooling the sample from the melt to at least 50° C. below the crystallization temperature, typically −50° C. for polypropylene, at a cooling rate of 20° C./min. The sample is held at this temperature (−50° C.) for at least 5 minutes, and finally heated at 10° C./min to acquire additional melting data (second heat). The endothermic melting transition (first and second heat) and exothermic crystallization transition are analyzed according to standard procedures. The melting temperatures reported are the peak melting temperatures from the second heat unless otherwise specified.

For polymers displaying multiple peaks, the melting temperature is defined to be the peak melting temperature from the melting trace associated with the largest endothermic calorimetric response (as opposed to the peak occurring at the highest temperature). Likewise, the crystallization temperature is defined to be the peak crystallization temperature from the crystallization trace associated with the largest exothermic calorimetric response (as opposed to the peak occurring at the highest temperature).

Areas under the DSC curve are used to determine the heat of transition (heat of fusion, H_{f}, upon melting or heat of crystallization, H_{c}, upon crystallization), which can be used to calculate the degree of crystallinity (also called the percent crystallinity). The percent crystallinity (X%) is calculated using the formula: [area under the curve (in J/g)/ H° (in J/g)]*100, where H° is the ideal heat of fusion for a perfect crystal of the homopolymer of the major monomer component. These values for H° are to be obtained from the Polymer Handbook, Fourth Edition, published by John Wiley and Sons, New York 1999, except that a value of 290 J/g is used for H° (polyethylene), a value of 140 J/g is used for H° (polybutene), and a value of 207 J/g is used for H° (polypropylene).

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. For example, the compositions described herein may be free of any component, or composition not expressly recited or disclosed herein. Any method may lack any step not recited or disclosed herein. Likewise, the term “comprising” is considered synonymous with the term “including.” And whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

1. A thermoformed article formed from a composition obtained by blending a propylene based polymer and a tackifying resin, wherein the tackifying resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof; wherein the article has a moisture vapor transmission rate of less than about 5 (g·mil)/m²-day and/or an oxygen transmission rate of less than about 110 (cc·mil)/100 in²-day.

2. The article of claim 1, wherein the propylene based polymer is nucleated via a nucleating agent.

3. The article of claim 2, wherein the nucleating agent is a clarifying agent.

4. The article of claim 1, wherein the tackifying resin has a softening point of from about 110° C. to about 150° C.

5. The article of claim 1, wherein the tackifying resin has a total dicyclopentadiene, cyclopentadiene, and methylcyclopentadiene derived content of from about 60 wt % to about 100 wt % of the total weight of the tackifying resin, and wherein the tackifying resin has a weight average molecular weight of from about 600 g/mole to about 1,400 g/mole.

6. The article of claim 1, wherein the propylene based polymer is selected from the group consisting of polypropylene homopolymer, impact copolymers of propylene, random copolymers of propylene, and combinations thereof.

7. The article of claim 1, wherein the propylene based polymer contains from about 0.5 wt % to about 7 wt % ethylene.

8. The article of claim 1, wherein the tackifying resin is present in the composition from about 2.5% to about 15% by weight based on the total weight of the composition.

9. The article of claim 8, wherein the tackifying resin is present in the composition from about 5% to about 10% by weight based on the total weight of the composition.

10. The article of claim 1, wherein the article has a haze value of from about 1% to about 10%, and wherein the article has a clarity value of greater than about 95%.

11. The article of claim 1, wherein the article is in the form of a multilayer sheet, and wherein at least one layer comprises the composition.

12. The article of claim 1, wherein the article is in the form of a thermoformed cup.

13. The article of claim 12, wherein the cup comprises a sidewall comprising the composition, wherein the cup has a sidewall thickness of from about 10 mils to about 15 mils, and wherein the sidewall has a haze value of from about 1% to about 3%.

14. The article of claim 12, wherein the cup has a top load compression strength of from about 250 N to about 325 N.

15. A method for making a thermoformed article, the method comprising:
a) adding a tackifying resin to a propylene based polymer to form a blend, wherein the tackifying resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof;
b) extruding the blend into sheet form; and
c) thermoforming the extruded blend.

16. The method of claim 15, further comprising nucleating the propylene based polymer prior to adding the tackifying resin.

17. The method of claim 16, wherein the tackifying resin has a softening point of from about 110° C. to about 150° C.

18. The method of claim 15, wherein the tackifying resin has a total dicyclopentadiene, cyclopentadiene, and methylcyclopentadiene derived content of from about 60 wt % to about 100 wt % of the total weight of the tackifying resin and a weight average molecular weight of from about 600 g/mole to about 1,400 g/mole.

19. The method of claim 15, wherein the propylene based polymer is selected from the group consisting of polypropylene homopolymer, impact copolymers of propylene, random copolymers of propylene, and combinations thereof.

20. The method of claim 15, wherein the propylene based polymer contains from about 0.5 wt % to about 7 wt % ethylene.

21. The method of claim 15, wherein the tackifying resin is present in the blend from about 2.5% to about 15% by weight based on the total weight of the blend.

22. The method of claim 15, wherein adding the tackifying resin increases the top load compression strength of the thermoformed article between about 5% to about 35%.

23. A method of improving the processability of a propylene based polymer, the method comprising adding a tackifying resin to a propylene based polymer to form a blend, wherein the tackifying resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof, and wherein the tackifying resin is added in an amount ranging from about 2.5% to about 15% by weight based on the total weight of the blend.

24. The method of claim 23, wherein the blend has a melt flow (MFR) from about 25% to about 50% greater than the MFR of the propylene based polymer.
